(19) United States
(12) Patent Application Publication
(10) Pub. No.: US 2013/0046916 A1
(43) Pub. Date: Feb. 21, 2013

(54) FIBRE ADAPTER FOR A SMALL FORM-FACTOR PLUGGABLE UNIT

(71) Applicants: Eric DUDEMAINE, Crabtree (CA); Renaud LAVOIE, Laval (CA); Dan BAKER, Orillia (CA); Brian FERRI, Milton (CA); John GRANT, Kitchener (CA); Fraser Clark, Carlisle (CA)

(72) Inventors: Eric DUDEMAINE, Crabtree (CA); Renaud LAVOIE, Laval (CA); Dan BAKER, Orillia (CA); Brian FERRI, Milton (CA); John GRANT, Kitchener (CA); Fraser Clark, Carlisle (CA)

(73) Assignee: AVP MFG & SUPPLY INC., Cambridge (CA)

(21) Appl. No.: 13/587,343

(22) Filed: Aug. 16, 2012

Related U.S. Application Data
(60) Provisional application No. 61/525,306, filed on Aug. 19, 2011.
(60) Provisional application No. 61/623,981, filed on Apr. 13, 2012.

(51) Int. Cl. G06F 13/00

(52) U.S. Cl. 710/317

(57) ABSTRACT

The disclosure is directed at a fibre adapter for use with small form factor pluggable (SFP) devices comprising a set of cages for receiving the SFP devices and a switch for interconnecting inputs and outputs of the set of cages.

### CROSS-REFERENCE TO OTHER APPLICATIONS

This application claims the benefit of U.S. Provisional Patent Application No. 61/525,306 filed Aug. 19, 2011, which is incorporated herein by reference.

### FIELD OF THE DISCLOSURE

The disclosure is generally directed at the field of video signals and more specifically at a fibre adapter that may be used with a small form-factor pluggable module or unit.

### BACKGROUND OF THE DISCLOSURE

Video signals are used in a variety of applications such as in the field of television where camera footage which is captured on site may be later processed to be displayed during a news cast. The video signals may also be used for live or recorded news, sports entertainment, entertainment event coverage, security and remote monitoring of industrial and natural processes.

These video signals may be delivered in many different formats through different types of connections. Some examples of these types of connections, include, but are not limited to, optical connections or copper co-axial connections. However, in the current art, the adapters which facilitate these connections are designed for a specific connection. Therefore, if one wishes to change the type of connection for signal transmission, the adapters must be replaced if they are not of the correct type.

Therefore, there is a need for a more adaptable fibre adapter using a small form-factor pluggable unit.

### BRIEF DESCRIPTION OF THE DRAWINGS

Other aspects and features of the present disclosure will become apparent to those ordinarily skilled in the art upon review of the following description of specific embodiments in conjunction with the accompanying figures.

FIG. 1a is a perspective view of a fibre adapter using a small form-factor pluggable (SFP) module or unit;

FIG. 1b is a perspective view of the fibre adapter mounted to a panel;

FIG. 2 is a schematic view of the fibre adapter in one mode of operation;

FIG. 3 is a schematic view of the fibre adapter in another mode of operation;

FIG. 4 is a schematic view of the fibre adapter in a third mode of operation;

FIG. 5 is a schematic view of the fibre adapter in a further mode of operation;

FIG. 6 is a schematic view of the fibre adapter in yet another mode of operation;

FIG. 7 is a schematic view of the fibre adapter in another mode of operation;

FIG. 8 is a schematic view of a further embodiment of a fibre adapter;

FIG. 9 is a flowchart outlining a method of configuring a fibre adapter;

FIG. 10a is a schematic diagram of a fibre adapter used as a dual DA Copper and optical to multiple outputs adapter;

FIG. 10b is a schematic diagram of a fibre adapter used as a dual bi-directional optical to copper convertor or adapter;

FIG. 10c is a schematic diagram of a fiber adapter used as optical loop through with HDMI monitor ports and HDBNC copper feeds adapter; and

FIG. 11 is a schematic diagram of another embodiment of a fibre adapter for an SFP module.

### DETAILED DESCRIPTION OF THE DISCLOSURE

The disclosure is directed at a fiber adapter for use with a small form-factor pluggable (SFP) unit or module that may be mounted in a panel designed for any size of high definition digital video jacks used in the industry. The adapter provides electronic switching of digital video signals in a manner that replicates the function of a passive mechanical video jack without the need for a mechanical switch. In addition, the fibre adapter may provide conversion from copper media to fiber media, fiber media to copper media, copper media to copper media or fibre media to fibre media, signal conditioning or, stabilization of the signal using industry standard such as, but not limited to, MAS compliant and noncompliant SFP modules.

In one embodiment, the adapter occupies two positions of a video jack panel to provide mechanical support and plug access through the front of the panel.

Currently, for devices which receive and transmit these video signals, users are generally limited to adapters which are designed for a single type of signal

In one embodiment, the disclosure uses an available industry standard module (SFP) that can provide many different real world interfaces on the fly without replacing individual adapters. In another embodiment, the adapters provide the ability to convert from copper to copper interfaces or copper to optical. In one such configuration, the adapter may be use to simulate or provide a half normaled digital video jack.

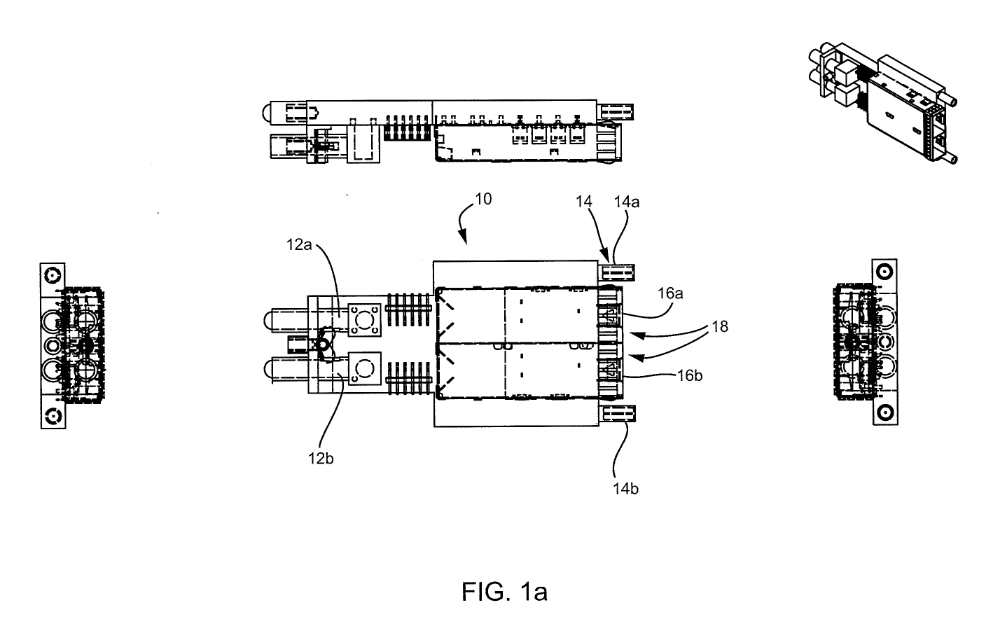

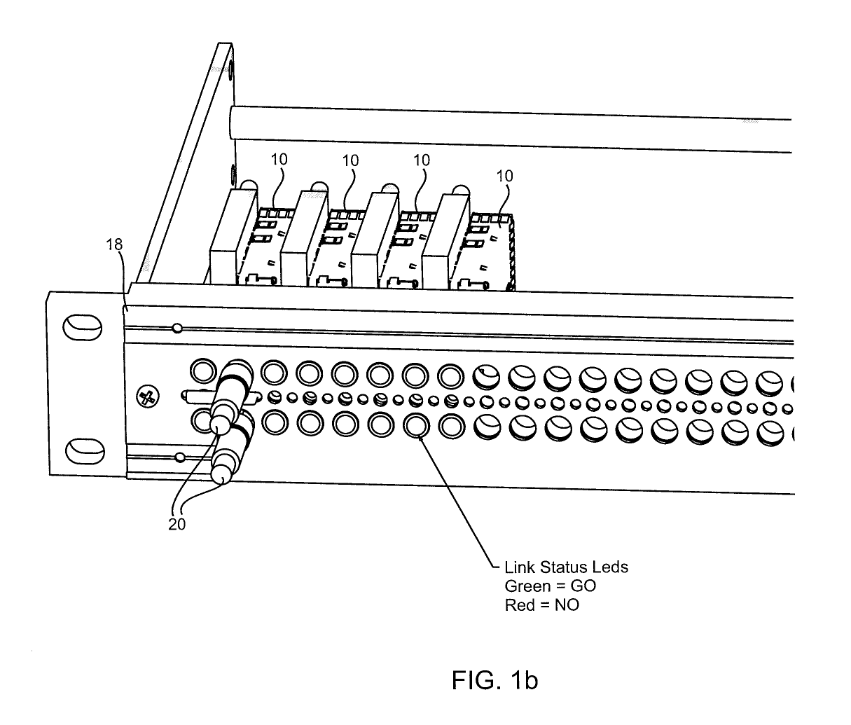

FIG. 1a is a schematic view of a fibre adapter in accordance with the disclosure. The fibre adapter 10 includes a pair of input/output ports 12, seen as a top I/O port 12a and a bottom I/O port 12b. The I/O ports 12 are, preferably, slide-in coaxial connectors that may accept any industry standard patch plugs to provide devices access to the signal being generated or transmitted within the adapter. Switching may also be performed using a carrier sense as will be described below. The adapter 10 is adapted to be connected to a pair of SFP cages 14 including a first, or top, SFP cage 14a and a second, or bottom, SFP cage 14b which are used for housing individual SFP modules. Between the pair of cages 14 are a further pair of input/output ports 16 seen as I/O port 16a and I/O port 16b. In a preferred embodiment, the I/O ports 16 may be coaxial connectors for copper media.

As shown in FIG. 1b, a set of four fibre adapters 10 are mounted to a video jack panel 18 and connected to a set of SFP cages 14. As shown, the pair of I/O ports 12 are mounted to the panel 18 and receive individual video jacks 20 for transmitting or receiving signals between the fibre adapter 10 and devices connected to the video jacks 20.

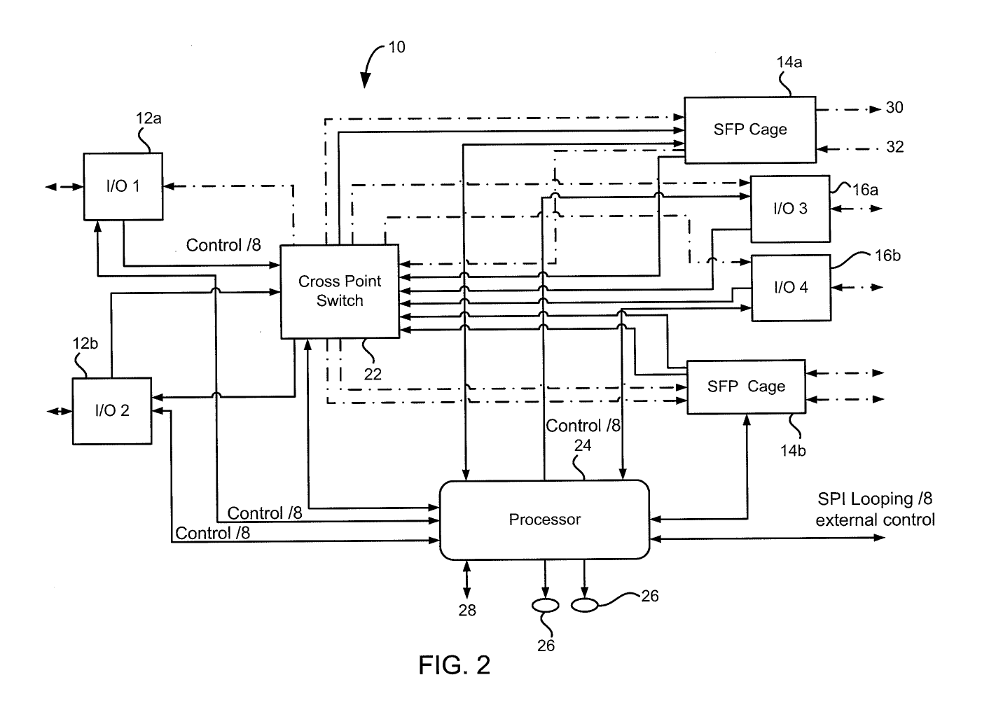

Turning to FIG. 2, a schematic diagram of circuitry within a fibre adapter is shown. While not all of the circuitry within the adapter 10 is shown, these will be well understood by those skilled in the art.

The adapter 10 includes the I/O ports 12a and 12b, adapted to be connected to the cages 14a and 14b and connected to the I/O ports 16a and 16b. Although each of the ports 12 and 16 and cages 14 have descriptors such as top, bottom and rear, these are simply for identification and not meant to indicate that the adapter must be set up in accordance with these relative positions or numbering.

Each of the ports 12 and 16 are connected to a cross point switch 22 which in the preferred embodiment is an 8×8 switch. The cross point switch 22 is further adapted to be, when installed, connected to the cages 14. The switch 22 provides multiple paths to replicate the switching action of a passive mechanical video jack, however, the adapter of the current disclosure operates in an active manner. A processor 24 is also located within the adapter 10 and controls parts of the operation of the adapter. The processor 24 may also serve as an interface with the cages 14, or SFP modules which have been inserted into the cages or an external device such that control of the adapter may be passed to a user or a person monitoring the adapter's operation. The processor 24 may also control a set of light emitting diodes (LEDs) 26 which help to indicate various adapter statuses so that information may be more easily and quickly conveyed to a user. A programming port 28 may also be provided in order to allow further changes or updates to the adapter to be made by a user.

By having electronic switching (via the switch 22), the adapter may provide the equivalent of an audio half normaled jack by providing an independent copy of the signal in one of the I/O ports 12, preferably the I/O port 12a. Furthermore, with electronic switching and a connection to SFP modules, the adapter may accept redundant copies of the signal and switch to the backup copy should the main feed be interrupted (as will be described). Also, with electronic switching, the processor may use the SFP modules to convert signals to and from copper, fibre or optical media when desired. With electronic switching, the adapter may provide a number of additional copies of the signal to multiple outputs. The adapter (or the processor) may also report the health of the adapter or the status of switched states and signal conditions at all inputs and outputs using an industry standard I²C bus. Finally, another advantage of the current disclosure is that the adapter may auto configure paths with electronic switching to match the capabilities of the SFP modules to which they are connected to.

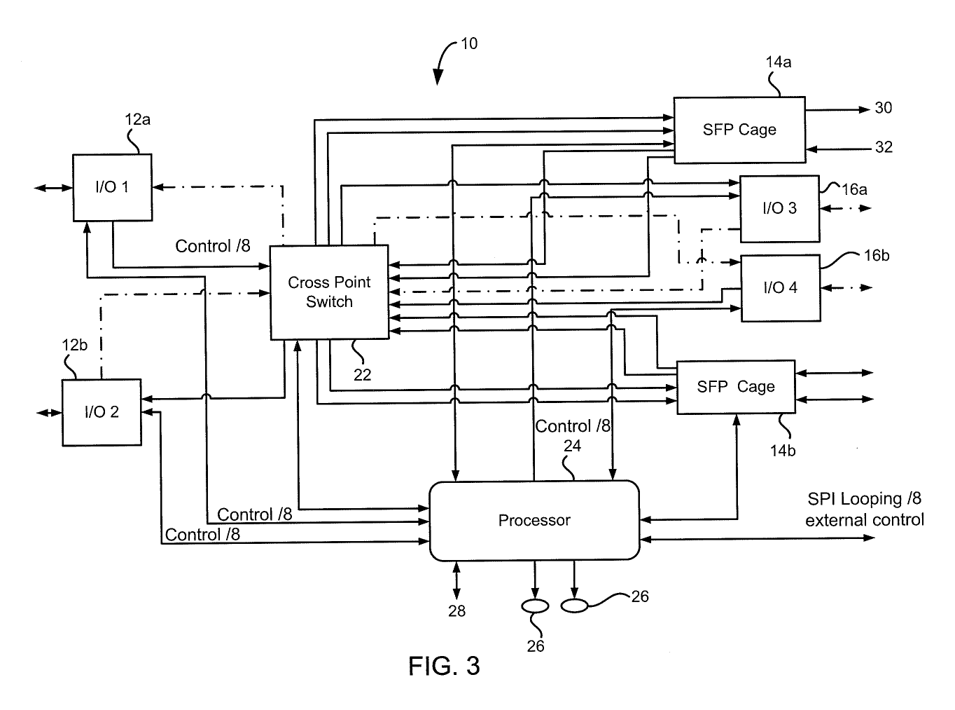

In a first mode of operation, as shown in FIG. 2 and the others, connections between the various components of the adapter and the SFP modules to which they may be connected are shown with connector lines, however, those which are shown in a solid state are for information only and are not in use. The connectors lines having alternating dash and dots represent signals being transmitted through the adapter 10. This also holds for FIGS. 3 to 7.

In FIG. 2, which can be seen as a Video Half Normal No Patches IN embodiment, it is assumed that the top cage 14a includes or houses a transceiver module which has one transmitter 30 and one receiver 32 while the bottom cage 14b includes or houses a transmitter module which includes a pair of transmitters 34 and 36. Examples of the modules may be the SFP and e-SFP™ modules developed by Embrionix, however the use of other SFP modules is contemplated. The I/O port 12a in this embodiment is used for output and the I/O port 12b may be used for either input or output while the two I/O ports 16 are both used as output ports.

In operation, when a signal is received at the receiver 32 in the top cage 14a, the signal, represented by the alternating dash-dot connector line is transmitted through to the switch 22. Depending on the inputted signal and the required output signal, the module within the top cage 14a does the necessary conversion of this signal. In one example, if the SFP modules are e-SFP™ modules from Embrionix, the e-SFP™ module within the top cage 14a may perform the necessary conversion of the inputted signal. For instance, if a copper signal is received and a fibre signal is required, the module converts the signal from copper to fiber and vice versa. Alternatively, in one embodiment, if a copper signal is required and a copper signal is received or if a fibre signal is require and a fibre signal is received, the e-SFP™ module from Embrionix in the top cage 14a simply passes the signal straight to the switch 22.

The switch 22 then replicates the signal, preferably without loss, into a predetermined number of identical signals and then transmits this signal to all those components which are connected to the switch 22 that are awaiting the signal. In this case, the signal is transmitted to I/O port 12a, the I/O ports 16a and 16b and the two cages 14a and 14b. In this manner, a received signal may be easily replicated and then provided to any sources or outputs.

As shown in FIG. 3, which can be seen as a Video Half Normal Lower Patch In Bottom No SFP and signal present embodiment, a video jack supplying a signal has been patched into the I/O port 12b for transmitting a signal. The I/O port 12a still acts as an output port while the two SFP cages 14a and 14b are empty and the I/O port 16a is operating as an input port and the I/O port 16b is acting as an output port.

In operation, the signal being transmitted from I/O port 16a passes through the switch (shown as the dot-dash line) and out to the I/O port 12a which the signal input at the I/O port 12b is transmitted through the switch 22 (shown as the dashed line) to the output port 16b. In this manner, different signals may be passed through the adapter independently with the switch controlling to which components the inputted or replicated signals are sent to. Alternatively, the instructions for where the inputted signals are transmitted may be sent from the processor via pre-programmed conditions or via instructions from an external control.

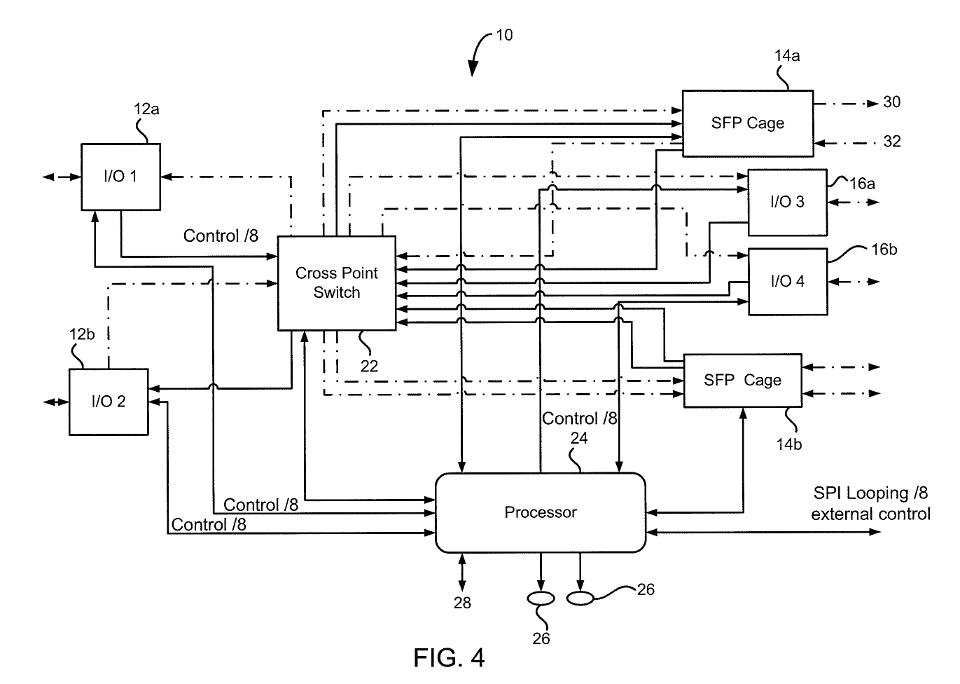

As shown in FIG. 4, which can be seen as a Video Half Normal Lower Patch IN Bottom and Signal present embodiment, the I/O port 12b acts as an input port to receive a signal which is patched from a video jack and the I/O port 12a acts as an output port. In one embodiment, within the top SFP cage is an e-SFP™ module from Embrionix that comprises a transceiver module and includes a transmitter portion 30 and a receiver portion 32 as in FIG. 2 while the module within the SFP cage 14b is preferably an e-SFP™ module from Embrionix with two transmitters while the I/O ports 16 act as output ports.

In operation, the receiver portion 32 receives a signal from an external component and if there is a conversion required, the module, such as an e-SFP™, makes the necessary conversion before transmitting the signal to the switch 22 which then outputs the signal to the I/O port 12a. In this embodiment, it is assumed that the signal received is ok and has not been corrupted. Typically, as in FIG. 2, the switch 22 would also transmit the signal to the other components, however, in the embodiment, the presence of a signal on the I/O port 12b causes this signal to be the primary signal. This may be signaled using carrier sensing. This primary signal is then transmitted to the switch 22, replicated and then passed to the I/O ports 16 and the top and bottom cages 14. After receiving the signals, the individual components transmit the signal to their connected devices.

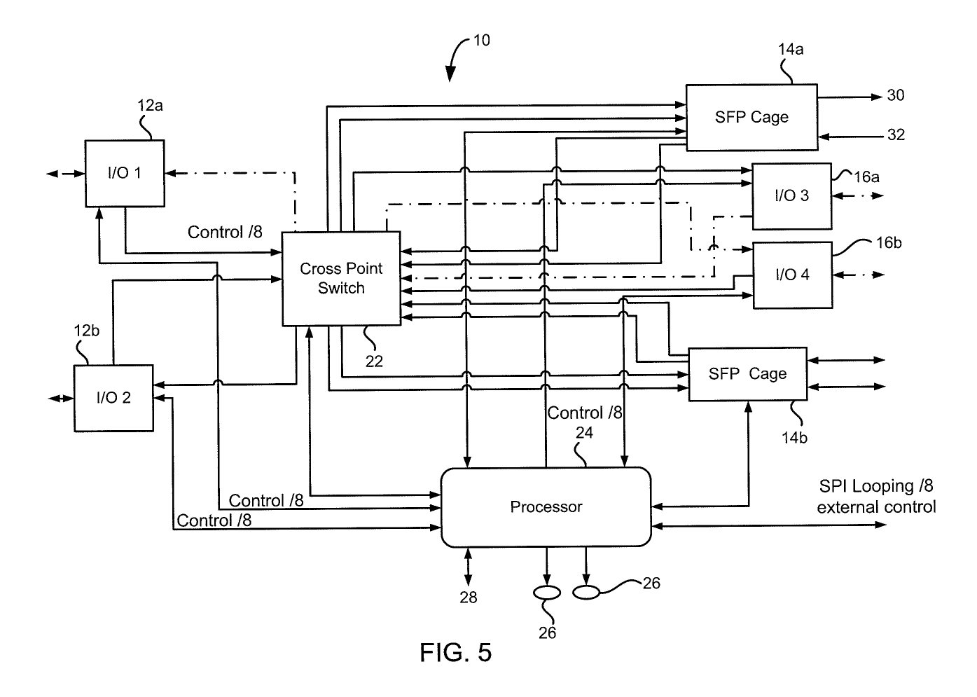

As shown in FIG. 5, which can be seen as a Video Half Normal NO Patches In No SFP embodiment, the I/O port 12b acts as an output port along with the I/O port 12a. Both of the SFP cages in this embodiment are empty and the I/O port 16a acts as an input port while the I/O port 16b acts as an output port. In this embodiment, the input signal is received from the I/O port 16a.

In operation, the I/O port 16a receives a signal as input and then transmits the signal to the switch 22 which then outputs the signal to the I/O port 12a and the I/O port 16b as shown by the arrowed dash-dot lines.

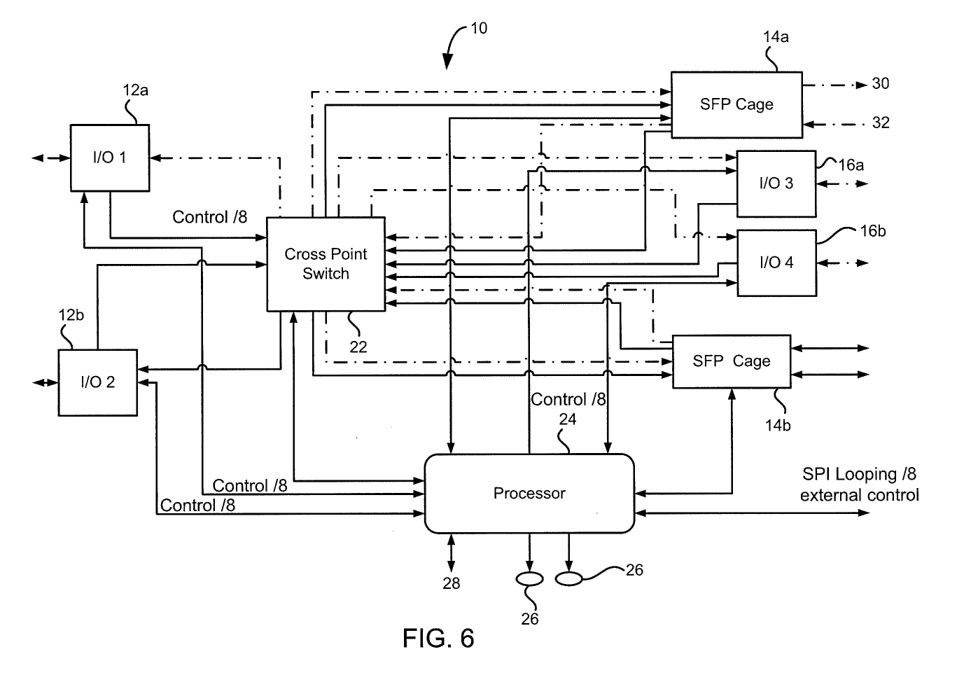

As shown in FIG. 6, which can be seen as a Video Half Normal No Patches In Redundant Feed OK, both the I/O ports 12 operate as output ports, however, the I/O port 12b may be an input port with no signal patched in. In one embodiment, within the top SFP cage is an e-SFP™ module from Embrionix that comprises a transceiver module which includes a transmitter portion 30 and a receiver portion 32 while within the SFP cage 14b is another e-SFP™ module from Embrionix that comprises a transceiver module in this embodiment. The I/O ports 16 act as output ports.

In operation, the receiver portion 32 of the e-SFP™ module receives a signal from an external component and if there is a conversion required, the e-SFP™ module within the top cage 14a makes the necessary conversion before transmitting the signal to the switch 22 which then outputs the signal to the I/O port 12a. The signal is then replicated at the switch 22 and then transmitted to the I/O port 12a, the I/O ports 16 and the e-SFP modules in the top and bottom cages.

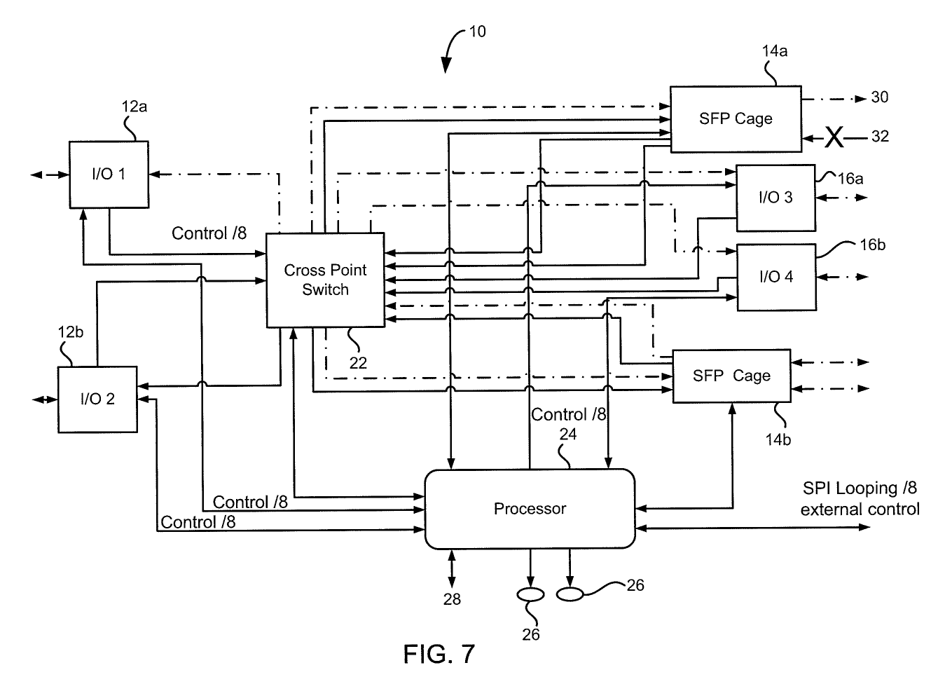

As shown in FIG. 7, which can be seen as a Video Half Normal No Patches In Redundant Feed Failure, both the I/O ports 12 operate as output ports, however, the I/O port 12b may be an input port with no signal patched in. In one embodiment, the modules within the top and bottom SFP cages to which the present adapter is connected are e-SFP™ modules comprising a transmitter portion 30 and a receiver portion 32. The I/O ports 16 act as output ports.

In operation, the receiver portion 32 receives a signal from an external component where the signal is deemed to have been corrupted and therefore, not usable. As the same signal may be provided on the receiver portion of the SFP module in the bottom cage 14b, this input signal may be used as the “signal”. The signal is then converted, if necessary, and transmitted to the switch 22 which replicates the signal. The signal is then replicated at the switch 22 and then transmitted to the I/O port 12a, the I/O ports 16 and the SFP modules in the top and bottom cages.

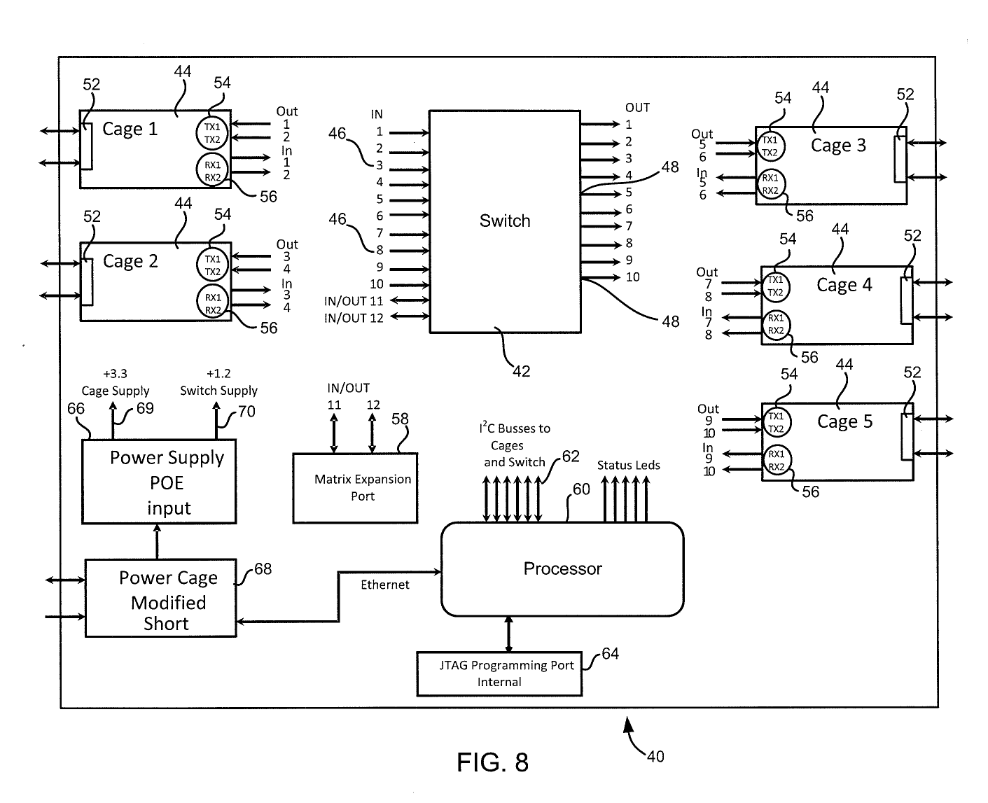

Turning to FIG. 8, a schematic diagram of an adapter in accordance with the disclosure is shown. The adapter 40 includes a switch 42 which is connected between a plurality of cages 44 which may receive either industry standard MAS compliant or non-compliant SFPs. Although only five (5) cages are shown, any number of cages may be connected to the switch with one limitation being the space available for the cages within the adapter housing or the number of connection points available within the switch 42.

The switch 42 includes a plurality of inputs or input ports 46 and a plurality of outputs or output ports 48. The switch may also include a set of dual input/outputs or dual ports 50. In the current example, the inputs, outputs and input/outputs are all labeled to identify their connection with the cages. The connections between the inputs 46 and the outputs 48 within the cages 44 are not directly linked for ease of display, however the labeling of the cage inputs and cage outputs provide one example of how the switch 42 may be connected with the cages 44. In one embodiment, the switch 42 is a 12×12 non blocking cross point switch that allows any SFP to be placed in any one of the cages such that any specified functionality is possible. As will be described below, the base adapter may benefit from being integrated with a software program or module to enhance the actual functions of the device or adapter.

In the current example, each of the SFP devices within the cages includes an interface portion which allows the cage 44 to receive from or transmit information to an external device. The cage has an interface 52 which interacts with the SFP device to receive these signals from external devices or to transfer signals to the SFP device for transmission to the external device. The transmission and receipt of signals or information between an external device and the SFP is known. Depending on the direction of signal transmission, the SFP device within the cage and the cage communicate to transfer the signals as necessary through a pair of output or transmitter ports 54 and a pair of input or receiver ports 56 to the switch 42 with respect to the information being provided by or to the external devices.

The adapter 40 may further include a matrix expansion port 58 which is connected to the dual input/output ports of the switch 42. A processor 60, preferably with Ethernet connectivity, LED drivers, includes a set of I²C busses 62 which are connected to the cages 44 and the switch 42. In one embodiment, the processor 60 supports HTTP and FTP protocols and communication with the cages 44 and the switch 42 via the I2C busses. The processor 60 further stores confirmation information and a unique MAC address for the adapter 40 allowing the adapter to communicate with other adapters or devices within a network of adapters or devices. The HTTP support may be used to host web pages that will assist in the configuration of the adapter, especially when the adapter has been implemented in the field. The FTP capability may be used for importing or exporting files into and out of the processor.

The processor 60 may also include an interface to communicate with a JTAG programming port 64 to receive input from an external source and may also control a set of status LEDS to provide indicators to a user as to which cages are currently in operation. In the preferred embodiment, there is one LED for each cage 44 whereby the LED indicates whether or not the associated cage is functioning properly or occupied. In one embodiment, if the cage is properly functioning, the associated LED remains lit, if there is a fault or no signal being supplied or received by the cage, the associated LED may flash or if the associated cage is empty or non-responsive, the associated LED may remain dark. Power may be provided to the processor 60 via a power supply 66 which is connected to the processor via a power cage 68. The power supply 66 may supply a cage supply voltage 69 and a switch supply voltage 70.

In another embodiment, the power is supplied from a Power over Ethernet (POE) connection that uses a modified (shortened) SFP casting and a modified SFP cage to make a locking power connection that has twenty (20) connections that will allow a primary and redundant POE (16 pins required). The primary connection however will be the only one to support a network interface and traffic.

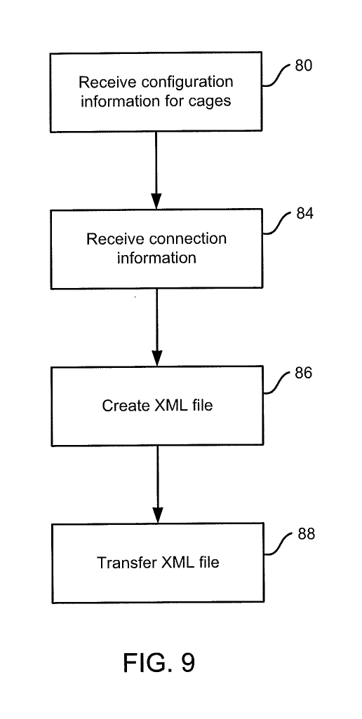

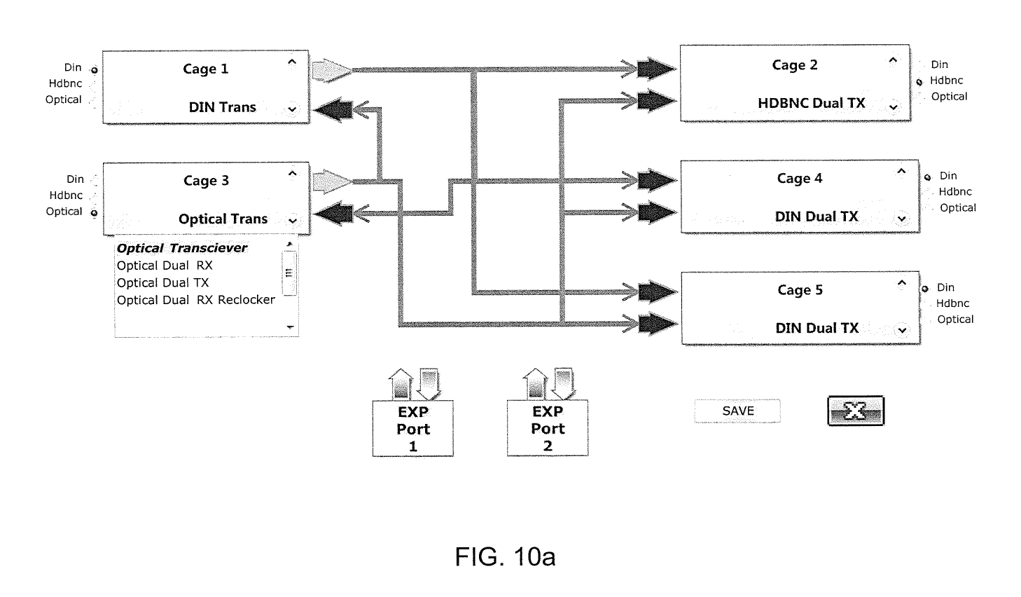

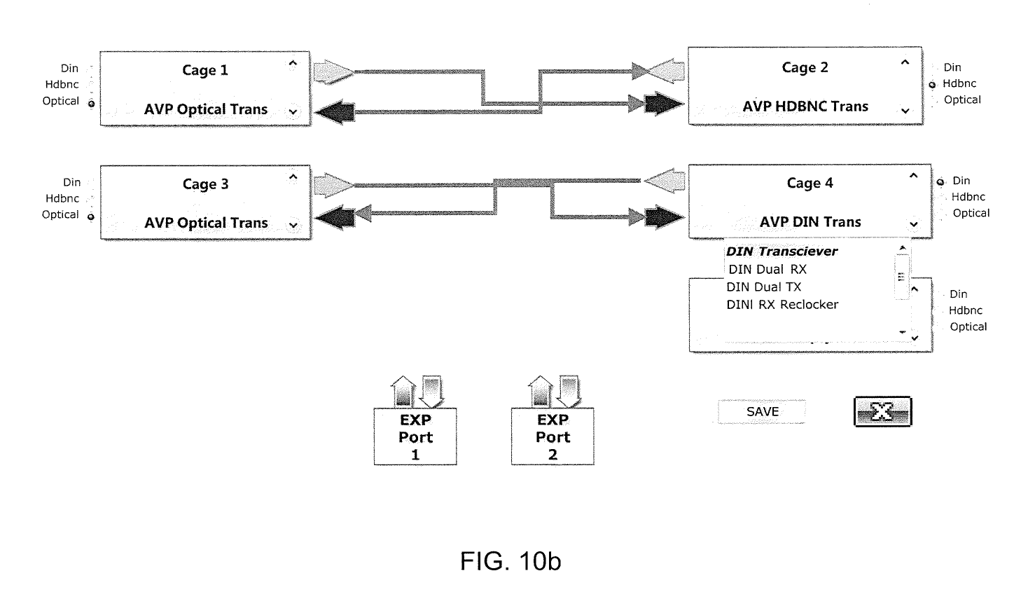

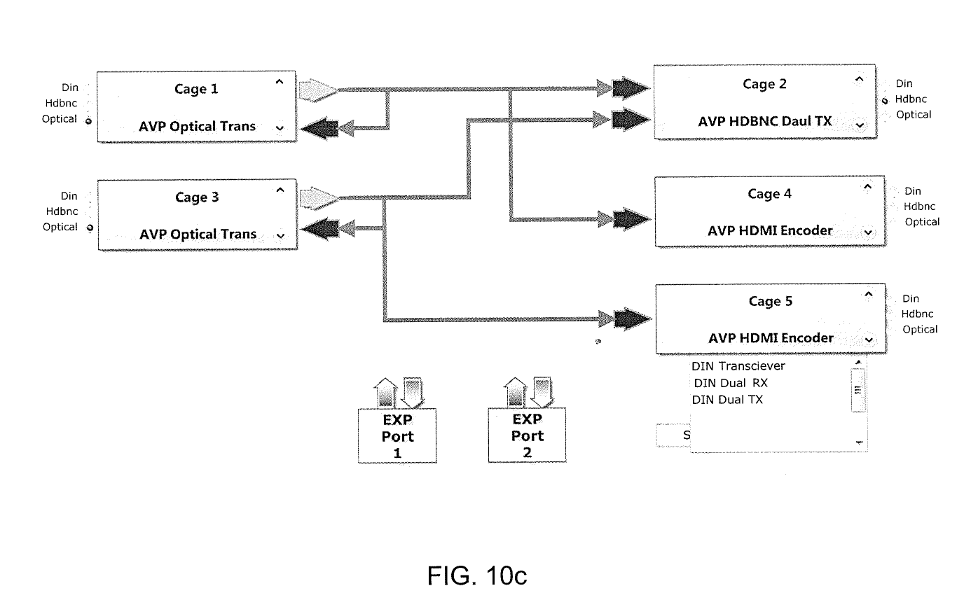

Turning to FIG. 9, a flowchart outlining a method of configuring an adapter, such as the adapter of FIG. 8, is shown. To begin the configuration, a user accesses a computer or processor, or the like, which may have stored within or may access from a server, software for configuring the adapter. After the user initiates the software, the user is provided with a graphical user interface for entering configuration information. The processor receives configuration information 80 for each of the cages. For instance, the user may be provided a drop down menu box for each cage of the adapter which lists the different devices or SFPs which may be inserted into the cage. Examples are schematically shown in FIGS. 10a to 10c below. In operation or configuration, not all of the cages need to be filled or connected, however, at least two cages need to have associated devices or SFPs.

The processor may then receive 84 connection information input by the user indicating how the cages are connected to each other via the switch. In one embodiment, the user may be provided with a graphical user interface (GUI), such as the ones shown in FIGS. 10a to 10c, which allows the user to easily connect the cages by drawing connections between the input and output ports or various cages. In one embodiment, the GUI is a user-friendly and interactive. Since most connections may be handled by the switch, most iterations and possible connections are possible.

After receiving this information, the processor produces 86 or creates an XML file to configure the adapter. In an alternative embodiment, a schematic drawing may be provided which may then be mounted to a housing of the adapter to illustrate the connections. Once the XML file is created, it may then be transmitted 88 to the adapter and then executed. Preferably, the XML file is transmitted via the external interface to the processor of the adapter. Once executed, the adapter is configured as per the inputs from the user and may then be integrated within system for use.

More specifically, with respect to actual examples, FIGS. 10a to 10c provide schematic screen shots of how adapters may be integrated.

Turning to FIGS. 10a to 10c, schematic views of different graphical user interfaces for setting up the adapters are provided.

In FIG. 10a, the adapter that is shown may be seen as a dual distribution amplifier (DA) copper and optical to multiple outputs adapter. In this embodiment, there are five cages in use for the adapter. As will be understood, the user does not need to be displayed the switch as those the connections between the switch and the input and output of the cages are inherently known as shown in FIG. 8. As shown in FIG. 10a, cage 1 has been associated with a DIN Transceiver, cage 2 has been associated with a HDBNC Dual transmitter, cage 3 has been associated with an optical transceiver, cage 4 has been associated with a DIN Dual transmitter and cage 5 has been associated with a DIN Dual transmitter. Although listed as devices, they may also be seen as modules in the cages.

As can be seen, each of the cages includes the option to select the type or category of device or module being placed in each cage. Although the only options shown are DIN, HDBNC and Optical, others may be contemplated. After the user selects one of these options, the user is provided with a drop down menu (such as shown with respect to cage 3) which allows the user to select the type of SFP device which is to be inserted into the cage based on the selected category. This may be seen as the aspect of configuration 80 in FIG. 9.

After determining the devices which are located in or associated with the various cages, the user is then provided with the opportunity to connect the inputs and outputs of the cages with other cages (seen as 84 in FIG. 9). In this embodiment, an output of the device in cage 1 is connected as an input to the devices in cages 2, 3, 4 and 5 while an input to the device in cage 1 is connected to an output of cage 3. The output of cage 3 is also connected as an input to cages 2, 4 and 5 while the input of cage 3. The expansion ports are unused in this arrangement. Therefore, as seen with respect to the adapter of FIG. 8, one of the outputs of cage 1 (seen as either RX1 or RX2) is connected to the switch and then one of the inputs of cages 2 to 5 (seen as either Tx1 or Tx2) are also connected to the switch or their connection to the switch is activated in order to implement the connections requested or required by the user. Similarly, the switch is transmitted information to associate the input at either input port 1 or 2 of the switch with output ports 3 or 4, 5 or 6, 7 or 8 and 9 or 10 connected with cages 2 to 5 respectively. Similar connections are provided for the output of cage 3 and its connections. After these connections are completed, the XML file may be created (seen as 86 in FIG. 9) and then the XML file is transmitted to an adapter so that the configuration requested by the user may be uploaded to the adapter and implemented (seen as 88 in FIG. 9). In one embodiment, the location, or IP address, of the adapter is known and therefore the XML file is transmitted via an email or simply over a network which is shared by the processor receiving the configuration information and the processor of the adapter. In another embodiment, the XML file is stored direction on an adapter once it has been created. This transfer may be performed using FTP or over a storage medium, such as a memory stick.

The signals transmitted by the output of cages 1 and cage 3 are provided by external devices which are connected to the SFP devices while the information that is input to the SFP devices in the cages is transmitted to the external devices connected thereto.

In FIG. 10b, the adapter that is shown may be seen as a dual bi-directional optical to copper convertor or adapter. In this embodiment, there are four cages in use for housing SFP devices. As shown cage 1 has been associated with an optical transceiver, cage 2 has been associated with a HDBNC transceiver, cage 3 has been associated with an optical transceiver and cage 4 has been associated with a DIN transceiver.

After the user selects one of the options, the user is provided with a drop down menu (such as shown with respect to cage 4) which allows the user to select the type of SFP device (in this example DIN SFP devices) which is to be inserted into the cage.

After determining the SFP devices which are located in the cages, the user is then provided with the opportunity to connect the inputs and outputs of the cages with other cages. In this embodiment, an output of the device in cage 1 is connected as an input to the device in cage 2 and vice-versa with the output of the device in cage 1 connected as an input to the device in cage 1. Similarly, the output of the device in cage 3 is connected as an input to the device in cage 4 and vice versa. As with the example of FIG. 10a, the switch is not shown to the user via this graphical user interface, however, the connections between the cages and the switch are inherently known or stored in a database. The expansion ports are unused in this arrangement.

As with the example of FIG. 10a above, the outputs of the cages are provided by external devices which are connected to the SFP devices while the information that is input to the SFP devices in the cages is then transmitted to these same connected external devices.

In FIG. 10c, the adapter that is shown may be seen as a optical loop through with HDMI monitor ports and HDBNC copper feeds adapter. In this embodiment, there are five cages in use for housing SFP devices. As shown cage 1 has been associated with an optical transceiver, cage 2 has been associated with a HDBNC Dual transmitter, cage 3 has been associated with an optical transceiver, cage 4 has been associated with a HDMI Encoder and cage 5 has been associated with a HDMI Encoder.

After the user selects one of the options, the user is provided with a drop down menu (such as shown with respect to cage 5) which allows the user to select the type of SFP device (in this example DIN SFP devices) which is to be inserted into the cage.

After determining the SFP devices which are located in the cages, the user is then provided with the opportunity to connect the inputs and outputs of the cages with other cages. In this embodiment, an output of the device in cage 1 is connected as an input to the device in cages 1, 2 and 4. An output of cage 3 is connected as an input to cages 2, 3 and 5. The expansion ports are unused in this arrangement.

As with the example of FIG. 10 a above, the outputs of the cages are provided by external devices which are connected to the SFP devices while the information that is input to the SFP devices in the cages is then transmitted to connected external devices.

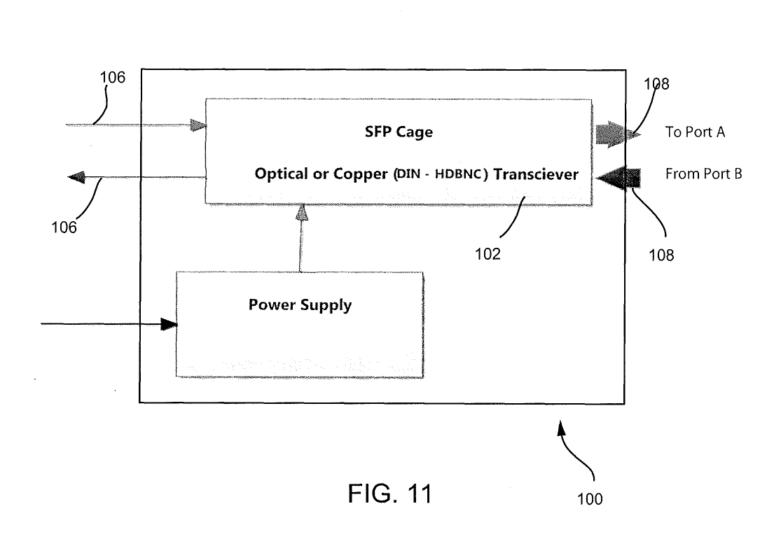

Turning to FIG. 11, a schematic diagram of a further embodiment of an adapter is shown. In this embodiment, there is a single SFP inserted.

The adapter 100 has a single cage 102 for receiving the SPF device. For instance the cage 102 may be used to receive an optical or copper (DIN or HDNCB) transceiver. Power is supplied to the cage, or the device in the cage, via a power supply 104. As with the previously described adapters, an external device may be connected to the cage, or the device within the cage, via ports 106 to transmit and receive signals or input with dual ports 108 which are located on an opposite side to the external device.

In the preceding description, for purposes of explanation, numerous details are set forth in order to provide a thorough understanding of the embodiments of the disclosure. However, it will be apparent to one skilled in the art that these specific details are not required in order to practice the disclosure.

The above-described embodiments of the disclosure are intended to be examples only. Alterations, modifications and variations can be effected to the particular embodiments by those of skill in the art without departing from the scope of the disclosure.

1. A fibre adapter for use with small form factor pluggable (SFP) devices comprising:
a set of cages for receiving the SFP devices; and
a switch for interconnecting inputs and outputs of the set of cages.

2. The fibre adapter of claim 1 further comprising:
a processor for controlling communication between the set of cages.

3. The fibre adapter of claim 2 wherein the processor further comprises an interface for receiving signals from an external source.

4. The fibre adapter of claim 1 wherein each of the set of cages includes an interface for transmitting and receiving signals from the SFP device.

5. The fiber adapter of claim 1 including further comprising apparatus for mounting the adapter to a jackfield.

6. The fiber adapter of claim 1 further comprising a matrix expansion port.

7. The fibre adapter of claim 1 wherein each of the set of cages includes a pair of input ports and a pair of output ports interfacing with the switch.

8. A method of implementing an adapter having a set of cages comprising:
receiving configuration information associated with devices in at least two of the set of cages;
receiving connection information between the at least two of the set of cages; and
creating an XML file based on the configuration and the connection information.

9. The method of claim 8 further comprising:
transmitting the XML file to a processor within the adapter.

10. The method of claim 9 wherein transmitting the XML file is performed over a network.

11. The method of claim 8 further comprising:
creating a schematic diagram based on the configuration and connection information.

12. A fibre adapter comprising:
at least one input port;
at least one output port; and
a switch for receiving a signal of interest from one of the at least one input ports and for replicating the signal of interest and transmitting the replicated signal at least one of the at least one output ports.

13. The fiber adapter of claim 1 wherein the input port is cage for receiving a small form factor pluggable device.
